(19) United States
(12) Patent Application Publication
(10) Pub. No.: US 2025/0175803 A1
(43) Pub. Date: May 29, 2025

(54) SYSTEMS AND METHODS FOR ERROR REPORTING FOR INTERMEDIARIES BETWEEN WIRELESS NETWORKS

(71) Applicant: Verizon Patent and Licensing Inc., Basking Ridge, NJ (US)

(72) Inventors: Yousif Targali, Sammamish, WA (US); Hossein M. Ahmadi, Parsippany, NJ (US); Vinod Kumar Choyi, Conshohocken, PA (US); Jignesh Patel, Colleyville, TX (US); Gerardo S. Libunao, Manalapan, NJ (US); Jay J. Lee, San Ramon, CA (US)

(73) Assignee: Verizon Patent and Licensing Inc., Basking Ridge, NJ (US)

(21) Appl. No.: 18/523,639

(22) Filed: Nov. 29, 2023

(51) Int. Cl. H04W 12/128; H04W 76/10

(52) U.S. Cl. CPC H04W 12/128; H04W 76/10

(57) ABSTRACT

A device described herein may establish a communication session with a first Security Edge Protection Proxy (“SEPP”) of a first network, and further with a second SEPP of a second network. The device may be or may implement an intermediary gateway between the SEPPs. The communication session may be associated with an N32-F interface that includes the SEPPs, the intermediary gateway, and one or more other intermediary gateways. The device may receive traffic from the first SEPP, and may determine that the traffic satisfies one or more error conditions. The device may identify an error reporting policy associated with the identified error condition, and may output, to the first SEPP and/or to the second SEPP (e.g., in accordance with the error reporting policy), an indication that the traffic satisfies the one or more error conditions.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. UEs may connect to different networks that are associated with different providers, carriers, Mobile Network Operators (“MNOs”), etc. For example, a network with which a UE is registered, provisioned, etc. may be considered as a “home” network of the UE, while another network to which the UE connects and receives wireless connectivity may be considered as a “roaming” or “visited” network. Different networks, such as a home network of a UE and networks to which the UE connects in a roaming scenario, may communicate with each other to coordinate authentication, authorization, charging, and/or other operations. Networks may utilize the Protocol for N32 Interconnect Security (“PRINS”) or other suitable protocols when communicating with each other in such a manner.

### BRIEF DESCRIPTION OF THE DRAWINGS

FIGS. 1 and 2 illustrate an example establishment of a communication session between different networks;

FIG. 3 illustrates example parameters and/or policies for communications between different networks, in accordance with some embodiments;

FIGS. 4-9 illustrate examples of identifying and reporting error conditions by one or more intermediaries between different networks, in accordance with some embodiments;

FIG. 10 illustrates an example process for identifying and reporting error conditions in traffic received via a communication session associated with different networks, in accordance with some embodiments;

FIGS. 11 and 12 illustrate example environments in which one or more embodiments, described herein, may be implemented;

FIG. 13 illustrates an example arrangement of a radio access network (“RAN”), in accordance with some embodiments; and

FIG. 14 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Wireless networks that communicate with each other using Security Edge Protection Proxies (“SEPPs”) may use intermediary gateways, such as Internet Protocol Exchange (“IPX”) systems, Roaming Hub (“RH”) systems, Roaming Value-Added Service (“RVAS”) systems, etc. to manage the routing and forwarding of traffic between the SEPPs of the respective wireless networks. Such intermediary gateways may be configured with rules, policies, etc. which may include Quality of Service (“QoS”) parameters, authorization parameters, traffic filters, routing policies, etc.

Situations may arise in which error conditions arise in the handling of traffic by such intermediaries. Such error conditions may include connectivity and/or reachability issues, inter-network access issues (e.g., where particular networks may not be authorized to communicate with each other), UE-specific access issues (e.g., where communications associated with a particular UE are not authorized such as situations where UE usage has exceeded a threshold), interface-specific issues (e.g., issues with an N32 interface), Service-Based Architecture (“SBA”)-related issues, and/or other types of issues. Embodiments described herein provide for the detection of error conditions by intermediary gateways, and the communication of such error conditions to respective SEPPs or other network functions (“NFs”) of one or more wireless networks. In this manner, networks may be made aware of error conditions detected by intermediary gateways and may perform remedial actions and/or troubleshooting in order to alleviate and prevent future occurrences of such error conditions. Further, providing error reporting functionality to intermediary gateways, in accordance some embodiments, may allow for the more reliable use of such intermediary gateways for robust functions such as enforcing rules and/or policies, and may further allow network operators to verify that the intermediary gateways are operating in accordance with their intended configuration parameters.

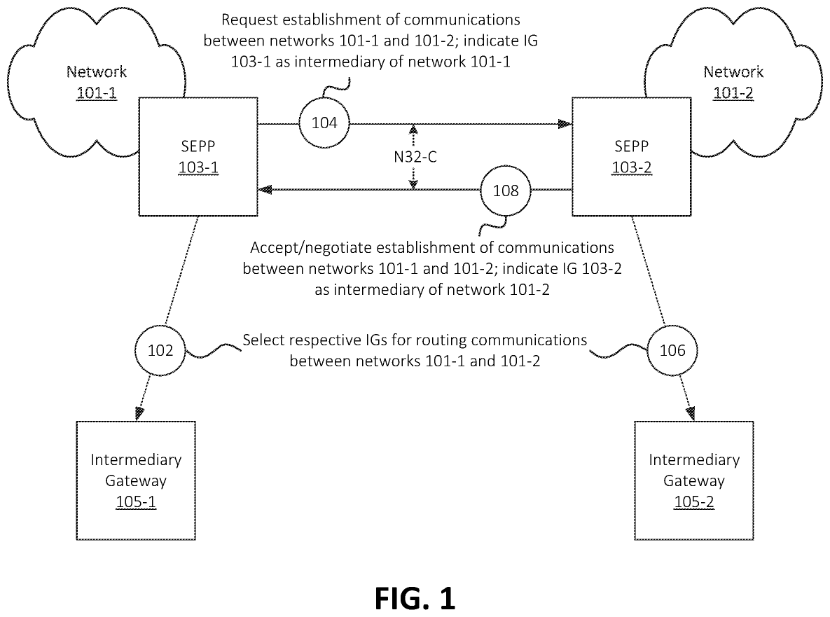

As shown in FIG. 1, two wireless networks (e.g., networks 101-1 and 101-2) may each be associated with respective SEPPs 103-1 and 103-2. SEPPs 103-1 and 103-2 may implement the PRINS protocol and/or some other suitable protocol or communication technique in order to securely communicate with each other. Such communications may include, for example, forwarding UE traffic (e.g., control plane signaling associated with one or more UEs such as N32 signaling, user plane traffic such as N9 traffic, etc.) between networks 101-1 and 101-2, exchanging usage information and/or other metrics, or other suitable types of communications. In this example, assume that network 101-1 (e.g., one or more elements of network 101-1) determines that network 101-1 should communicate with network 101-2, such as a situation in which a UE for which network 101-2 is a home network connects to network 101-1 (e.g., the UE is “roaming on” or is “visiting” network 101-1). SEPP 103-1 may select (at 102) a particular Intermediary Gateway (“IG”) 105-1. As discussed above, IG 105-1 may include an IPX system, an RH system, an RVAS system, and/or other type of suitable device or system that is configured to operate according to one or more particular protocols or interfaces (e.g., an N32-F interface).

SEPP 103-1 may further request (at 104) an establishment of a communication session between networks 101-1 and 101-2 (e.g., between SEPPs 103-1 and 103-2). The request (at 104) may include an identifier of IG 105-1 (e.g., an Internet Protocol (“IP”) address or other suitable identifier). That is, SEPP 103-1 may indicate, to SEPP 103-2, that IG 105-1 is an intermediary for the requested communication session between SEPP 103-1 and SEPP 103-2. The request (at 104) may include other information, such as authentication information that may be used by SEPP 103-2 to authenticate SEPP 103-1 and/or other suitable information.

Assuming that network 101-2 (e.g., SEPP 103-2) approves the request from network 101-1, SEPP 103-2 may select (at 106) IG 105-2 to act as an intermediary for communications between SEPPs 103-1 and 103-2. In some embodiments, SEPP 103-2 may provide, to IG 105-2, an identifier of IG 105-1, such that IG 105-2 is “aware” that IG 105-1 is an intermediary for SEPP 103-1.

SEPP 103-2 may respond (at 108) to SEPP 103-1 with an indication that the requested communication session is approved. In some situations, SEPPs 103-1 and 103-2 may negotiate one or more parameters of the communication session before SEPP 103-2 indicates an acceptance of the request. SEPP 103-2 may further provide (at 108) an indication that IG 105-2 has been selected by SEPP 103-2 as an intermediary for the requested communication session. SEPP 103-1 may provide, to IG 105-1, an identifier of IG 105-2, such that IG 105-1 is “aware” that IG 105-2 is an intermediary for SEPP 103-2. SEPPs 103-1 and 103-2 may communicate (at 104 and 108) via an N32-C interface. The N32-C interface may be used for an initial handshake or parameter exchange between SEPPs 103-1 and 103-2.

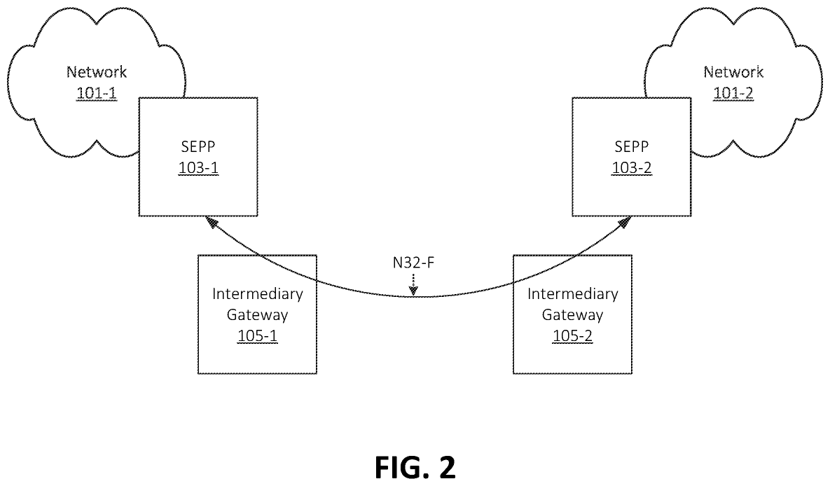

The requested communication session, once established, may implement, may include, and/or may otherwise be associated with an N32-F interface. As shown in FIG. 2, the N32-F interface may include SEPPs 103-1 and 103-2 as ultimate endpoints, with IGs 105-1 and 105-2 serving as intermediaries for traffic sent between SEPPs 103-1 and 103-2. In accordance with the N32-F interface, SEPP 103-1 may direct communications, ultimately destined for SEPP 103-2, to IG 105-1. For example, SEPP 103-1 may output communications to an IP address of IG 105-1, along with an indication that such communications are ultimately directed to SEPP 103-2. IG 105-1 may identify that IG 105-2 is associated with SEPP 103-2, and may forward such communications to IG 105-2 (e.g., using an IP address of IG 105-2), along with an indication that such communications are ultimately directed to SEPP 103-2 and an indication that the communications were initially sent from SEPP 103-1. IG 105-2 may accordingly forward the communications to SEPP 103-2.

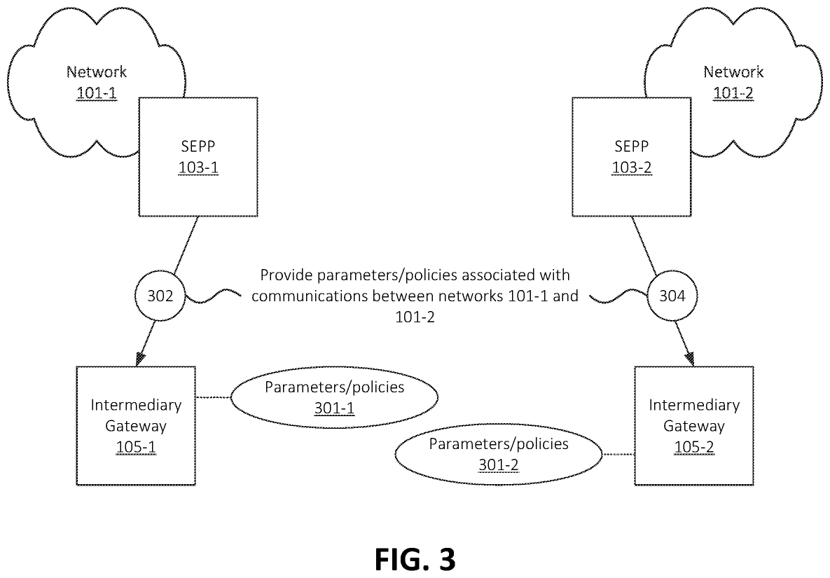

As shown in FIG. 3 and in accordance with some embodiments, SEPP 103-1 (and/or some other suitable device or system) may provide (at 302) a set of parameters and/or policies 301-1 associated with communications between networks 101-1 and 101-2. Similarly, IG 105-2 may receive (at 304) a set of parameters and/or policies 301-2 (e.g., from SEPP 103-2 and/or from some other suitable source). Such parameters and/or policies 301-1 and/or 301-2 may be used by IGs 105-1 and/or 105-2 to evaluate communications sent between SEPPs 103-1 and 103-2, to detect error conditions (e.g., violations of respective parameters and/or policies 301-1 and/or 301-2), and to alert SEPPs 103-1 and/or 103-2 as to the occurrence of such error conditions. In some embodiments, IGs 105-1 and 105-2 may receive different sets of parameters and/or policies 301-1 and 301-2. Examples are provided below of the use of respective parameters and/or policies 301-1 and/or 301-2, by IGs 105-1 and/or 105-2, to detect and report error conditions, in accordance with some embodiments.

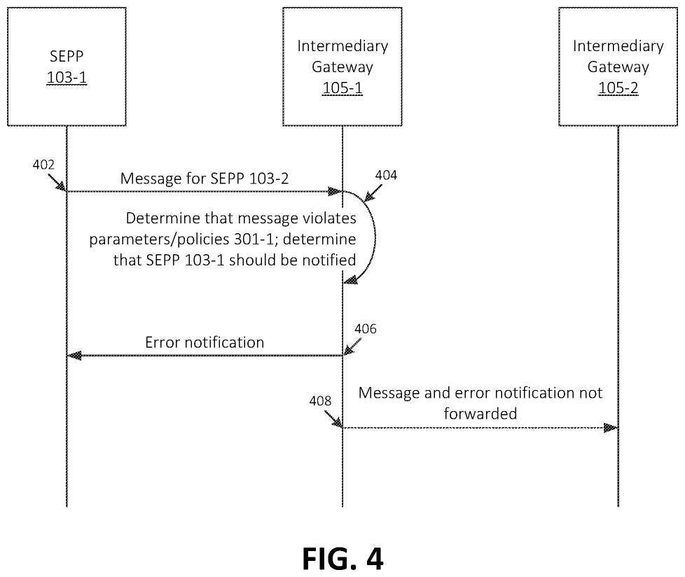

As shown in FIG. 4, SEPP 103-1 may output (at 402) traffic (e.g., one or more messages) for SEPP 103-2 (e.g., via an N32 interface). For example, SEPP 103-1 may indicate that an ultimate destination of the one or more messages is SEPP 103-2, and may output the one or more messages to IG 105-1 for forwarding to SEPP 103-2 (e.g., via one or more respective intermediaries, such as IG 105-2). Upon receiving the one or more messages, IG 105-1 may analyze the one or more messages (e.g., header and/or payload information) and may determine that the one or more messages violate one or more parameters and/or policies 301-1. The violated parameters and/or policies 301-1 may be, in this instance, parameters and/or policies relating to an N32 interface (e.g., communications directed to SEPP 103-2).

As one example, parameters and/or policies 301-1 may indicate particular information elements (“IEs”) that are required or expected to be included in messages (e.g., N32 messages) from SEPP 103-1 to SEPP 103-2, and IG 105-1 may detect (at 404) that one or more of such IEs are not included in the one or more messages (e.g., are omitted entirely, or in an undetectable form such as in an encrypted form). As another example, parameters and/or policies 301-1 may indicate particular IEs that are required or expected to be encrypted in messages from SEPP 103-1 to SEPP 103-2, and IG 105-1 may detect (at 404) that one or more of such IEs are included in the one or more messages in unencrypted form. As another example, parameters and/or policies 301-1 may indicate that SEPP 103-1 is not authorized to share particular information or types of information with SEPP 103-2, and IG 105 may detect (at 404) that such information is included in the one or more messages.

As another example, the message received (at 402) from SEPP 103-1 may indicate a connection setup (e.g., a setup of an N32-F interface between SEPPs 103-1 and 103-2), and IG 105-1 may detect that the requested connection is not permitted by parameters and/or policies 301-1. For example, IG 105-1 may identify that network 101-1 (e.g., SEPP 103-1) is not authorized to communicate with network 101-2 (e.g., SEPP 103-2). As yet another example, the message received (at 402) from SEPP 103-1 may indicate a connection setup between SEPPs 103-1 and 103-2 as well as an identifier of a UE with which the requested connection is associated, and IG 105-1 may detect that the requested connection (e.g., the connection on behalf of the UE) is not permitted by parameters and/or policies 301-1, such as in situations where the UE is not associated with a subscription or plan that provides such access.

In some embodiments, parameters and/or policies 301-1 may specify an error reporting policy for one or more of the above error conditions. In this example, such error reporting policy may indicate that IG 105-1 should notify SEPP 103-1 of the detected error condition, without notifying network 101-2 (e.g., IG 105-2 and/or SEPP 103-2). Accordingly, IG 105-1 may output (at 406) an error notification to SEPP 103-1, indicating that the error condition was detected with respect to the one or more messages sent (at 402) by SEPP 103-1. The error notification may include an identification of the particular parameters and/or policies 301-1 that were violated, may include metadata (e.g., a time of detection of the error condition, a time at which IG 105-1 received the one or more messages, etc.), and/or other suitable information.

One or more elements of network 101-1 may communicate with SEPP 103-1 to identify the error condition, and may use the information included in the error notification to modify configuration parameters or perform other types of troubleshooting or remediation measures. For example, one or more NFs may subscribe to error notifications (or error notifications meeting particular criteria, such as notifications of particular types of errors or notifications associated with particular UEs), and may receive the error notification from SEPP 103-1 based on the subscription. As further shown, since parameters and/or policies 301-1 did not indicate that network 101-2 should be notified regarding the particular detected type of error, IG 105-1 may forgo (at 408) forwarding the error notification and/or the one or more messages to IG 105-2.

On the other hand, in some embodiments, parameters and/or policies 301-1 may specify that a particular type of error is a “warning” or “information” type of error, and IG 105-1 may proceed to forward messages detected with such error to IG 105-2, while additionally providing a notification to SEPP 103-1 of the detected “warning” or “information” type of error.

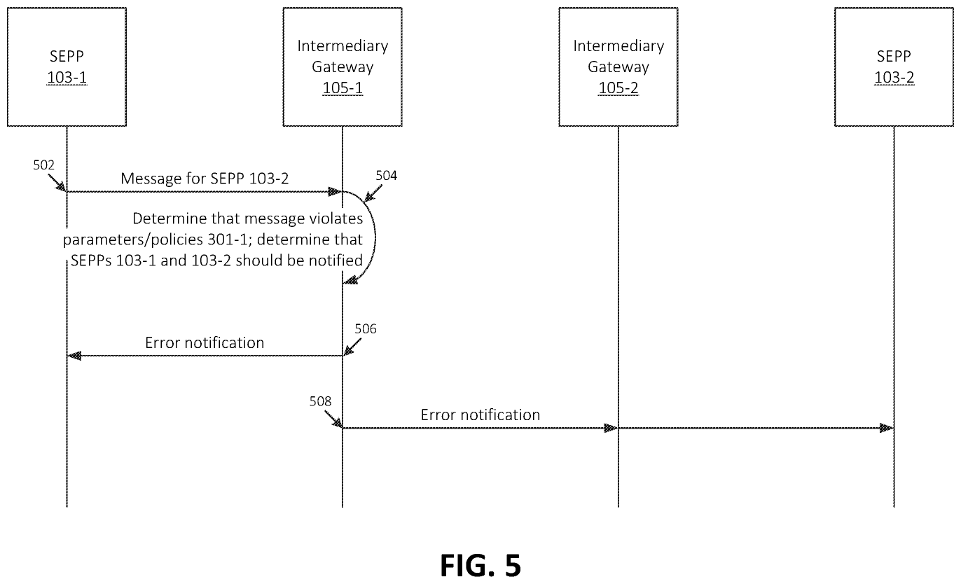

In the example of FIG. 5, IG 105-1 may detect (at 504) one or more error conditions associated with one or more messages sent (at 502) by SEPP 103-1 for SEPP 103-2. Some examples of such error conditions are discussed above with respect to FIG. 4. In this example, IG 105-1 may determine (at 504) that SEPPs 103-1 and 103-2 may both be notified of the detected error condition. For example, parameters and/or policies 301-1 may specify that SEPPs 103-1 and 103-2 should be notified of the error condition. As such, IG 105-1 may notify (at 506) SEPP 103-1 of the detected error condition, and may output (at 508) an error notification for SEPP 103-2 to IG 105-2. IG 105-2 may receive the error notification and may accordingly forward the error notification to SEPP 103-2.

In some scenarios, parameters and/or policies 301-1 may specify that the one or more messages, in which the error condition was detected, should not be forwarded to SEPP 103-2. In such scenarios, IG 105-1 may forgo outputting such messages to SEPP 103-2 (e.g., via IG 105-2). On the other hand, in some scenarios, parameters and/or policies 301-1 may specify that the one or more messages, in which the error condition was detected, should be forwarded to SEPP 103-2 (e.g., the error condition may be a “warning” or “information” type of error). In such scenarios, IG 105-1 may output such messages to SEPP 103-2 (e.g., via IG 105-2), while also outputting (at 508) the error notification.

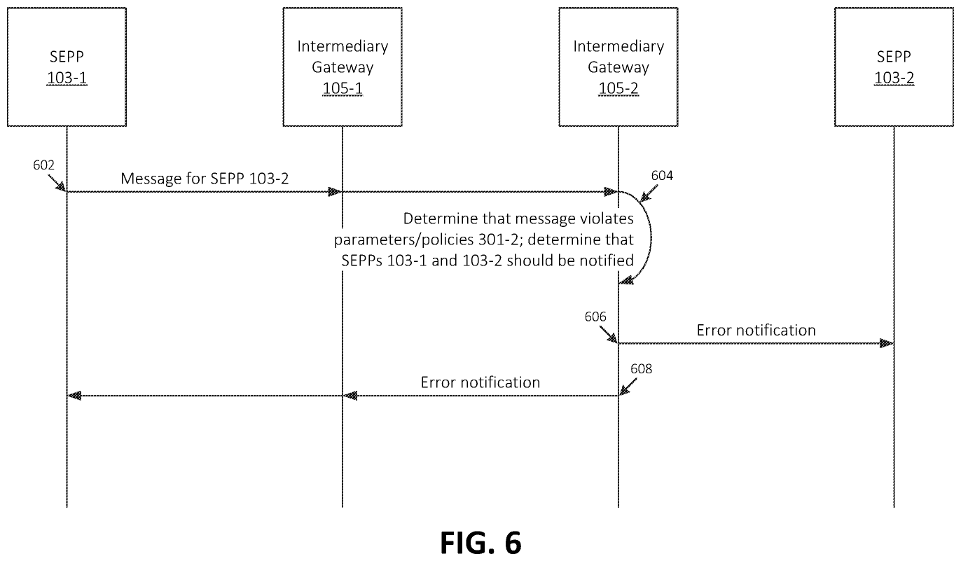

As shown in FIG. 6, communications between SEPPs 103-1 and 103-2 may not necessarily violate parameters and/or policies associated with one IG 105, but may violate parameters and/or policies associated with another IG 105. For example, IG 105-1 may receive (at 602) a message destined for SEPP 103-2, and may forward the message to IG 105-2 with which SEPP 103-2 is associated. For example, IG 105-1 may evaluate the message and may determine that the message does not violate parameters and/or policies 301-1 with which IG 105-1 is associated, and/or may otherwise determine that the message should be forwarded toward SEPP 103-2 (e.g., via IG 105-2). Upon receiving the message, IG 105-2 may determine (at 604) that the message violates parameters and/or policies 301-2 maintained by IG 105-2. As noted above, IGs 105-1 and 105-2 may maintain different respective parameters and/or policies 301-1 and 301-2. As such, communications satisfying one set of parameters and/or policies may violate another. IG 105-2 may accordingly output (at 606 and/or 608) an error notification to SEPP 103-2 and/or SEPP 103-1. In some embodiments, IG 105-2 may output (at 606) an error notification only to SEPP 103-2 (e.g., not to SEPP 103-1), or may output (at 608) an error notification only to SEPP 103-1 (e.g., not to SEPP 103-2), based on any applicable error reporting policies indicated by parameters and/or policies 301-2.

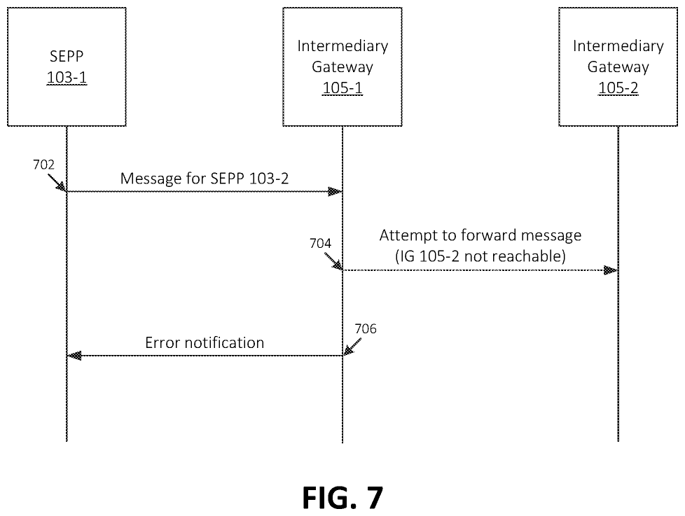

As shown in FIG. 7, IG 105-1 may also detect connectivity issues, which may not necessarily be specifically indicated in parameters and/or policies 301-1. For example, IG 105-1 may attempt (at 704) to forward a message, received (at 702) from SEPP 103-1, to IG 105-2 for delivery to SEPP 103-2. In this example, the attempt may be unsuccessful, due to connectivity and/or availability issues. For example, a network link or other communication pathway between IGs 105-1 and 105-2 may be malfunctioning, overloaded, or otherwise non-operational. As another example, IG 105-2 may reject the message (e.g., based on overload or malfunction of IG 105-2). IG 105-1 may accordingly output (at 706) an error notification to SEPP 103-1, indicating that the message was not delivered to, or was not accepted by, IG 105-2. In some embodiments, IG 105-1 may cache, buffer, maintain, etc. information indicating that the attempt to forward the message (at 704) to IG 105-2 was unsuccessful. In some embodiments, when IG 105-1 is able to communicate with IG 105-2 at some future time, IG 105-1 may provide an error notification to IG 105-2, indicating that IG 105-1 attempted (at 704) to forward a message to IG 105-2 and was unsuccessful in doing so.

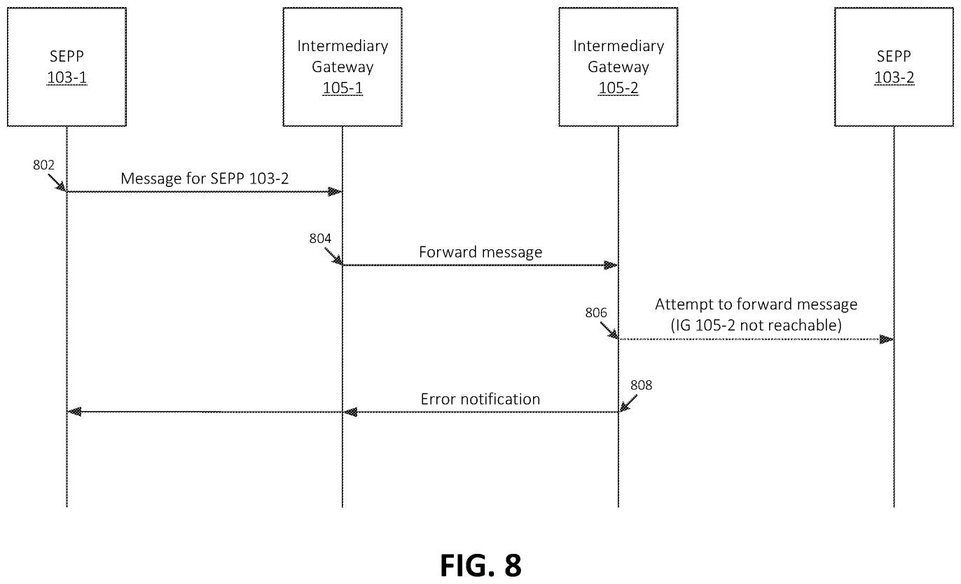

As similarly shown in FIG. 8, IG 105-1 may receive (at 802) a message from SEPP 103-1, intended for SEPP 103-2 (e.g., indicating SEPP 103-2 as an ultimate destination for the message). IG 105-1 may identify that IG 105-2 is an intermediary for SEPP 103-2, and may accordingly forward (at 804) the message to IG 105-2 for delivery to SEPP 103-2. IG 105-2 may attempt (at 806) to forward the message, but the attempt may be unsuccessful due to a connectivity issue, a reachability issue, an overloading of SEPP 103-2, and/or some other cause. Accordingly, IG 105-2 may output (at 808) an error notification to IG 105-1, which may forward the error notification to SEPP 103-1. As similarly discussed above, IG 105-2 may cache, buffer, etc. the error notification and may notify SEPP 103-2 at some subsequent time (e.g., when IG 105-2 is able to communicate with SEPP 103-2) that IG 105-2 attempted (at 806) to forward a message to SEPP 103-2, but was unsuccessful in doing so.

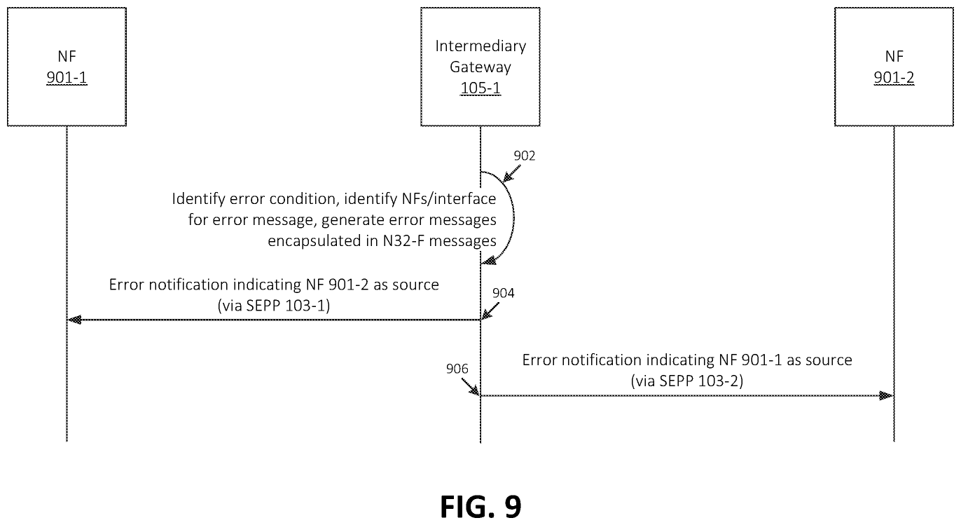

In some embodiments, IGs 105 may provide enhanced communication functionality between NFs of different networks 101-1 and 101-2. For example, as shown in FIG. 9, IG 105-1 may identify (at 902) an error condition, such as based on evaluating one or more messages between SEPPs 103-1 and 103-2 of networks 101-1 and 101-2. In some embodiments, IG 105-1 may identify that the one or more messages satisfy criteria or conditions specified in parameters and/or policies 301-1, where such parameters and/or policies 301-1 further specify that the error notification should be directed to one or more NFs (e.g., NF 901-1 of network 101-1 and/or NF 901-2 of network 101-2). As discussed above, the error conditions may include errors associated with communications between SEPPs 103-1 and 103-2 (e.g., N32 interface errors) or other types of errors, such as errors associated with communications between NFs of networks 101-1 and 101-2 (e.g., SBA-based errors).

As one example of an SBA-based error, IG 105-1 may determine that an amount of usage by a particular UE (e.g., a UE with which communications between SEPPs 103-1 and 103-2 of networks 101-1 and 101-2 are associated) has exceeded a threshold. SEPPs 103-1 may identify that particular NFs 901-1 and 901-2 of networks 101-1 and 101-2, respectively (e.g., an Session Management Function (“SMF”) of network 101-1 and an SMF of network 101-2), should be notified. IG 105-1 may output (at 904) an error notification to SEPP 103-1, indicating NF 901-1 (e.g., an SMF of network 101-1) as a destination for the error notification. In some embodiments, the error notification may be generated in accordance with one or more interfaces, protocols, message types, etc. with which NF 901-1 is associated. For example, the error notification may include or may implement an N16 interface (e.g., an interface used for communications between SMFs). IG 105-1 may send the error notification, which is associated with the N16 interface, to SEPP 103-1 via the N32-F interface established between IG 105-1 and SEPP 103-1. For example, the error notification may include one or more N16 messages encapsulated in one or more N32-F messages. SEPP 103-1 may decapsulate, extract, etc. the one or more encapsulated messages for NF 901-1 (e.g., one or more N16 messages for the SMF of network 101-1), and may forward such messages to NF 901-1.

In some embodiments, the error notification (e.g., the one or more N16 messages) may indicate NF 901-2 (e.g., an SMF of network 101-2) as a source of the error notification. In this manner, NF 901-1 may receive or process the error notification as if the notification was received from NF 901-2 via an interface associated with NFs 901-1 and 901-2 (e.g., an N16 interface between SMFs). In some embodiments, SEPP 103-1 may authenticate IG 105-1 and/or verify that IG 105-1 is authorized to indicate that the source of the error notification is another entity (e.g., NF 901-2). Additionally, or alternatively, the error notification from IG 105-1 may include an identifier of IG 105-1, an authentication token associated with IG 105-1, and/or some other identifier or mechanism via which NF 901-1 may identify that the error message was generated by IG 105-1 (e.g., in addition to being associated with NF 901-2). For example, such authentication mechanisms may have been established between NF 901-1 and IG 105-1, such that NF 901-1 is able to authenticate such messages from IG 105-1, and is further able to determine that IG 105-1 is authorized to provide such messages (e.g., error notifications associated with other NFs, such as NF 901-2, or other types of messages or instructions) to NF 901-1.

In some embodiments, in lieu of IG 105-1 indicating the error notification for NF 901-1, SEPP 103-1 may identify an error condition to report to NF 901-1, and may generate one or more appropriate messages or notifications for NF 901-1. Such messages may implement or otherwise be associated with an interface or protocol associated with such NF 901-1, such as an N16 interface as discussed above. Similarly, SEPP 103-1 may indicate that a source of such messages is some other entity, such as NF 901-2.

Similarly, IG 105-1 may output (at 906) an error notification or other suitable type of message toward NF 901-2 (e.g., via IG 105-2 and/or SEPP 103-2), indicating NF 901-1 as a source of the message. For example, the error notification may implement a protocol, interface, etc. used for communicating with NF 901-2 (e.g., an N16 interface used to communicate with SMFs), and may be encapsulated in one or more N32-F messages to IG 105-2 and/or SEPP 103-2. SEPP 103-2 may decapsulate the message (e.g., extract the N16 message from the N32-F message), where the decapsulated message indicates NF 901-1 as the source and NF 901-2 as the destination. In this sense, NF 901-2 may receive the message as if the message were sent from NF 901-1. In this manner, IG 105-1 may provide a “pseudo” interface between NFs 901-1 and 901-2, as if such NFs were directly communicating with each other.

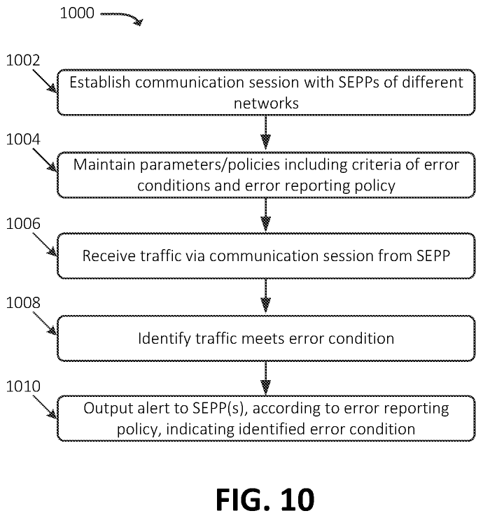

FIG. 10 illustrates an example process 1000 for identifying and reporting error conditions in traffic received via a communication session associated with SEPPs 103 of different networks 101. In some embodiments, some or all of process 1000 may be performed by a particular IG 105 (e.g., associated with a particular SEPP 103).

As shown, process 1000 may include establishing (at 1002) a communication session with SEPPs 103 of different networks 101 (e.g., SEPPs 103-1 and 103-2 of networks 101-1 and 101-2). As discussed above, the communication session may include, may be associated with, may implement, etc. an N32-F interface. The communication session may be set up in accordance with parameters and/or policies negotiated or otherwise determined by SEPPs 103-1 and/or 103-2 (e.g., as communicated via an N32-C interface). As discussed above, SEPP 103-1 may have selected the particular IG 105 (e.g., IG 105-1) as an intermediary for communications between SEPP 103-1 and SEPP 103-2, and SEPP 103-1 may have indicated (e.g., via N32-C messaging) to SEPP 103-2 that IG 105-1 is an intermediary for communications between SEPPs 103-1 and 103-2. Similarly, SEPP 103-2 may have selected a respective IG 105 (e.g., IG 105-2), and may indicate to SEPP 103-1 that IG 105-2 is an intermediary between SEPPs 103-1 and 103-2. In this manner, SEPPs 103-1 and 103-2, as well as IGs 105-1 and 105-2, may be included in the communication session (e.g., the N32-F communication session).

Process 1000 may further include maintaining (at 1004) parameters and/or policies 301, including criteria of error conditions. As discussed above, parameters and/or policies 301 may also include an error reporting policy, indicating which SEPP(s) 103 are to receive error notifications of particular error conditions. As discussed above, the error conditions may include, for example, communication and/or reachability errors, network-based errors (e.g., certain networks 101 may not be authorized to communicate particular messages or types of messages), UE-based errors (e.g., certain UEs may not be authorized to communication particular messages or types of messages, or a UE may have exceeded a threshold amount of usage, etc.), and/or other suitable types of errors.

Process 1000 may additionally include receiving (at 1006) traffic from one or more of the SEPPs 103 with which the communication session is associated. For example, IG 105-1 may receive traffic from SEPP 103-1 (e.g., SEPP 103-1 may directly address traffic to IG 105-1, with SEPP 103-2 as an ultimate destination of the traffic). As another example, IG 105-1 may receive traffic from SEPP 103-2, which may include receiving such traffic via IG 105-2 with which SEPP 103-2 is associated (e.g., as established during an N32-C communication session between SEPPs 103-1 and 103-2). The traffic may include traffic associated with one or more UEs, such as control plane signaling or other suitable traffic.

Process 1000 may also include identifying (at 1008) that the traffic meets an error condition specified in the parameters and/or policies. For example, IG 105-1 may analyze the traffic, perform deep packet inspection (“DPI”), identify header information, or otherwise identify attributes of the traffic. IG 105-1 may compare the attributes of the traffic (e.g., header information, payload information, etc.) to the criteria included in the parameters and/or policies, and may identify that the traffic meets the criteria associated with a particular error condition indicated in the parameters and/or policies.

Process 1000 may further include outputting (at 1010) an alert to SEPPs 103-1 and/or 103-2, according to the error reporting policy. The alert may indicate that the traffic meets the criteria associated with the error condition. As discussed above, IG 105-1 may output the alert to SEPP 103-1, SEPP 103-2, or both, depending on the error reporting policy. Respective networks 101-1 and/or 101-2 may accordingly take remedial action based on receiving the alert, such as modifying network parameters, to rectify the indicated error condition.

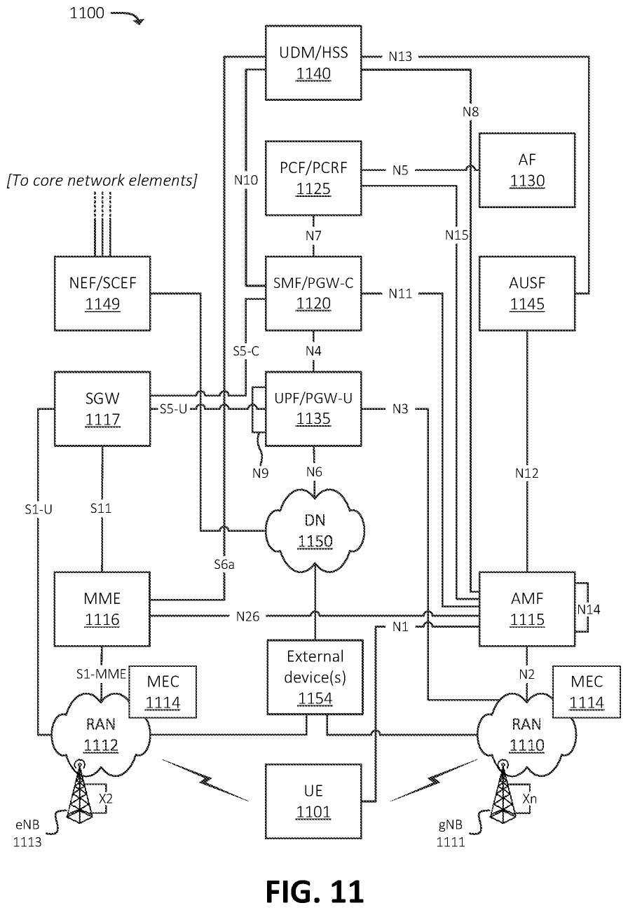

FIG. 11 illustrates an example environment 1100, in which one or more embodiments may be implemented. In some embodiments, environment 1100 may correspond to a Fifth Generation (“5G”) network, and/or may include elements of a 5G network. In some embodiments, environment 1100 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 1100 may represent or may include a 5G core (“5GC”). As shown, environment 1100 may include UE 1101, RAN 1110 (which may include one or more Next Generation Node Bs (“gNBs”) 1111), RAN 1112 (which may include one or more evolved Node Bs (“eNBs”) 1113), and various network functions such as Access and Mobility Management Function (“AMF”) 1115, Mobility Management Entity (“MME”) 1116, Serving Gateway (“SGW”) 1117, SMF/Packet Data Network (“PDN”) Gateway (“PGW”)-Control plane function (“PGW-C”) 1120, Policy Control Function (“PCF”)/Policy Charging and Rules Function (“PCRF”) 1125, Application Function (“AF”) 1130, User Plane Function (“UPF”)/PGW-User plane function (“PGW-U”) 1135, Unified Data Management (“UDM”)/Home Subscriber Server (“HSS”) 1140, Authentication Server Function (“AUSF”) 1145, and Network Exposure Function (“NEF”)/Service Capability Exposure Function (“SCEF”) 1149. Environment 1100 may also include one or more networks, such as Data Network (“DN”) 1150. Environment 1100 may include one or more additional devices or systems communicatively coupled to one or more networks (e.g., DN 1150), such as one or more external devices 1154.

The example shown in FIG. 11 illustrates one instance of each network component or function (e.g., one instance of SMF/PGW-C 1120, PCF/PCRF 1125, UPF/PGW-U 1135, UDM/HSS 1140, and/or AUSF 1145). In practice, environment 1100 may include multiple instances of such components or functions. For example, in some embodiments, environment 1100 may include multiple “slices” of a core network, where each slice includes a discrete and/or logical set of network functions (e.g., one slice may include a first instance of AMF 1115, SMF/PGW-C 1120, PCF/PCRF 1125, and/or UPF/PGW-U 1135, while another slice may include a second instance of AMF 1115, SMF/PGW-C 1120, PCF/PCRF 1125, and/or UPF/PGW-U 1135). The different slices may provide differentiated levels of service, such as service in accordance with different Quality of Service (“QoS”) parameters.

The quantity of devices and/or networks, illustrated in FIG. 11, is provided for explanatory purposes only. In practice, environment 1100 may include additional devices and/or networks, fewer devices and/or networks, different devices and/or networks, or differently arranged devices and/or networks than illustrated in FIG. 11. For example, while not shown, environment 1100 may include devices that facilitate or enable communication between various components shown in environment 1100, such as routers, modems, gateways, switches, hubs, etc. In some implementations, one or more devices of environment 1100 may be physically integrated in, and/or may be physically attached to, one or more other devices of environment 1100. Alternatively, or additionally, one or more of the devices of environment 1100 may perform one or more network functions described as being performed by another one or more of the devices of environment 1100.

Additionally, one or more elements of environment 1100 may be implemented in a virtualized and/or containerized manner. For example, one or more of the elements of environment 1100 may be implemented by one or more Virtualized Network Functions (“VNFs”), Cloud-Native Network Functions (“CNFs”), etc. In such embodiments, environment 1100 may include, may implement, and/or may be communicatively coupled to an orchestration platform that provisions hardware resources, installs containers or applications, performs load balancing, and/or otherwise manages the deployment of such elements of environment 1100. In some embodiments, such orchestration and/or management of such elements of environment 1100 may be performed by, or in conjunction with, the open-source Kubernetes® application programming interface (“API”) or some other suitable virtualization, containerization, and/or orchestration system.

Elements of environment 1100 may interconnect with each other and/or other devices via wired connections, wireless connections, or a combination of wired and wireless connections. Examples of interfaces or communication pathways between the elements of environment 1100, as shown in FIG. 11, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 11, such as Service-Based Interfaces (“SBIs”), including an Namf interface, an Nudm interface, an Npcf interface, an Nupf interface, an Nnef interface, an Nsmf interface, and/or one or more other SBIs. some embodiments, environment 1100 may be, may include, may be implemented by, and/or may be communicatively coupled to networks 101-1 and/or 101-2. For example, network 101-1 may include a first instance of environment 1100 and network 101-2 may include a second instance of environment 1100.

UE 1101 may include a computation and communication device, such as a wireless mobile communication device that is capable of communicating with RAN 1110, RAN 1112, and/or DN 1150. UE 1101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), a Fixed Wireless Access (“FWA”) device, or another type of mobile computation and communication device. UE 1101 may send traffic to and/or receive traffic (e.g., user plane traffic) from DN 1150 via RAN 1110, RAN 1112, and/or UPF/PGW-U 1135.

RAN 1110 may be, or may include, a 5G RAN that includes one or more base stations (e.g., one or more gNBs 1111), via which UE 1101 may communicate with one or more other elements of environment 1100. UE 1101 may communicate with RAN 1110 via an air interface (e.g., as provided by gNB 1111). For instance, RAN 1110 may receive traffic (e.g., user plane traffic such as voice call traffic, data traffic, messaging traffic, etc.) from UE 1101 via the air interface, and may communicate the traffic to UPF/PGW-U 1135 and/or one or more other devices or networks. Further, RAN 1110 may receive signaling traffic, control plane traffic, etc. from UE 1101 via the air interface, and may communicate such signaling traffic, control plane traffic, etc. to AMF 1115 and/or one or more other devices or networks. Additionally, RAN 1110 may receive traffic intended for UE 1101 (e.g., from UPF/PGW-U 1135, AMF 1115, and/or one or more other devices or networks) and may communicate the traffic to UE 1101 via the air interface.

RAN 1112 may be, or may include, a LTE RAN that includes one or more base stations (e.g., one or more eNBs 1113), via which UE 1101 may communicate with one or more other elements of environment 1100. UE 1101 may communicate with RAN 1112 via an air interface (e.g., as provided by eNB 1113). For instance, RAN 1112 may receive traffic (e.g., user plane traffic such as voice call traffic, data traffic, messaging traffic, signaling traffic, etc.) from UE 1101 via the air interface, and may communicate the traffic to UPF/PGW-U 1135 (e.g., via SGW 1117) and/or one or more other devices or networks. Further, RAN 1112 may receive signaling traffic, control plane traffic, etc. from UE 1101 via the air interface, and may communicate such signaling traffic, control plane traffic, etc. to MME 1116 and/or one or more other devices or networks. Additionally, RAN 1112 may receive traffic intended for UE 1101 (e.g., from UPF/PGW-U 1135, MME 1116, SGW 1117, and/or one or more other devices or networks) and may communicate the traffic to UE 1101 via the air interface.

One or more RANs of environment 1100 (e.g., RAN 1110 and/or RAN 1112) may include, may implement, and/or may otherwise be communicatively coupled to one or more edge computing devices, such as one or more Multi-Access/Mobile Edge Computing (“MEC”) devices (referred to sometimes herein simply as a “MECs”) 1114. MECs 1114 may be co-located with wireless network infrastructure equipment of RANs 1110 and/or 1112 (e.g., one or more gNBs 1111 and/or one or more eNBs 1113, respectively). Additionally, or alternatively, MECs 1114 may otherwise be associated with geographical regions (e.g., coverage areas) of wireless network infrastructure equipment of RANs 1110 and/or 1112. In some embodiments, one or more MECs 1114 may be implemented by the same set of hardware resources, the same set of devices, etc. that implement wireless network infrastructure equipment of RANs 1110 and/or 1112. In some embodiments, one or more MECs 1114 may be implemented by different hardware resources, a different set of devices, etc. from hardware resources or devices that implement wireless network infrastructure equipment of RANs 1110 and/or 1112. In some embodiments, MECs 1114 may be communicatively coupled to wireless network infrastructure equipment of RANs 1110 and/or 1112 (e.g., via a high-speed and/or low-latency link such as a physical wired interface, a high-speed and/or low-latency wireless interface, or some other suitable communication pathway).

MECs 1114 may include hardware resources (e.g., configurable or provisionable hardware resources) that may be configured to provide services and/or otherwise process traffic to and/or from UE 1101, via RAN 1110 and/or 1112. For example, RAN 1110 and/or 1112 may route some traffic from UE 1101 (e.g., traffic associated with one or more particular services, applications, application types, etc.) to a respective MEC 1114 instead of to core network elements of 1100 (e.g., UPF/PGW-U 1135). MEC 1114 may accordingly provide services to UE 1101 by processing such traffic, performing one or more computations based on the received traffic, and providing traffic to UE 1101 via RAN 1110 and/or 1112. MEC 1114 may include, and/or may implement, some or all of the functionality described above with respect to UPF/PGW-U 1135, AF 1130, one or more application servers, and/or one or more other devices, systems, VNFs, CNFs, etc. In this manner, ultra-low latency services may be provided to UE 1101, as traffic does not need to traverse links (e.g., backhaul links) between RAN 1110 and/or 1112 and the core network.

AMF 1115 may include one or more devices, systems, VNFs, CNFs, etc., that perform operations to register UE 1101 with the 5G network, to establish bearer channels associated with a session with UE 1101, to hand off UE 1101 from the 5G network to another network, to hand off UE 1101 from the other network to the 5G network, manage mobility of UE 1101 between RANs 1110 and/or gNBs 1111, and/or to perform other operations. In some embodiments, the 5G network may include multiple AMFs 1115, which communicate with each other via the N14 interface (denoted in FIG. 11 by the line marked “N14” originating and terminating at AMF 1115).

MME 1116 may include one or more devices, systems, VNFs, CNFs, etc., that perform operations to register UE 1101 with the EPC, to establish bearer channels associated with a session with UE 1101, to hand off UE 1101 from the EPC to another network, to hand off UE 1101 from another network to the EPC, manage mobility of UE 1101 between RANs 1112 and/or eNBs 1113, and/or to perform other operations.

SGW 1117 may include one or more devices, systems, VNFs, CNFs, etc., that aggregate traffic received from one or more eNBs 1113 and send the aggregated traffic to an external network or device via UPF/PGW-U 1135. Additionally, SGW 1117 may aggregate traffic received from one or more UPF/PGW-Us 1135 and may send the aggregated traffic to one or more eNBs 1113. SGW 1117 may operate as an anchor for the user plane during inter-eNB handovers and as an anchor for mobility between different telecommunication networks or RANs (e.g., RANs 1110 and 1112).

SMF/PGW-C 1120 may include one or more devices, systems, VNFs, CNFs, etc., that gather, process, store, and/or provide information in a manner described herein. SMF/PGW-C 1120 may, for example, facilitate the establishment of communication sessions on behalf of UE 1101. In some embodiments, the establishment of communications sessions may be performed in accordance with one or more policies provided by PCF/PCRF 1125.

PCF/PCRF 1125 may include one or more devices, systems, VNFs, CNFs, etc., that aggregate information to and from the 5G network and/or other sources. PCF/PCRF 1125 may receive information regarding policies and/or subscriptions from one or more sources, such as subscriber databases and/or from one or more users (such as, for example, an administrator associated with PCF/PCRF 1125).

AF 1130 may include one or more devices, systems, VNFs, CNFs, etc., that receive, store, and/or provide information that may be used in determining parameters (e.g., quality of service parameters, charging parameters, or the like) for certain applications.

UPF/PGW-U 1135 may include one or more devices, systems, VNFs, CNFs, etc., that receive, store, and/or provide data (e.g., user plane data). For example, UPF/PGW-U 1135 may receive user plane data (e.g., voice call traffic, data traffic, etc.), destined for UE 1101, from DN 1150, and may forward the user plane data toward UE 1101 (e.g., via RAN 1110, SMF/PGW-C 1120, and/or one or more other devices). In some embodiments, multiple instances of UPF/PGW-U 1135 may be deployed (e.g., in different geographical locations), and the delivery of content to UE 1101 may be coordinated via the N9 interface (e.g., as denoted in FIG. 11 by the line marked “N9” originating and terminating at UPF/PGW-U 1135). Similarly, UPF/PGW-U 1135 may receive traffic from UE 1101 (e.g., via RAN 1110, RAN 1112, SMF/PGW-C 1120, and/or one or more other devices), and may forward the traffic toward DN 1150. In some embodiments, UPF/PGW-U 1135 may communicate (e.g., via the N4 interface) with SMF/PGW-C 1120, regarding user plane data processed by UPF/PGW-U 1135.

UDM/HSS 1140 and AUSF 1145 may include one or more devices, systems, VNFs, CNFs, etc., that manage, update, and/or store, in one or more memory devices associated with AUSF 1145 and/or UDM/HSS 1140, profile information associated with a subscriber. In some embodiments, UDM/HSS 1140 may include, may implement, may be communicatively coupled to, and/or may otherwise be associated with some other type of repository or database, such as a Unified Data Repository (“UDR”). AUSF 1145 and/or UDM/HSS 1140 may perform authentication, authorization, and/or accounting operations associated with one or more UEs 1101 and/or one or more communication sessions associated with one or more UEs 1101.

DN 1150 may include one or more wired and/or wireless networks. For example, DN 1150 may include an Internet Protocol (“IP”)-based PDN, a wide area network (“WAN”) such as the Internet, a private enterprise network, and/or one or more other networks. UE 1101 may communicate, through DN 1150, with data servers, other UEs 1101, and/or to other servers or applications that are coupled to DN 1150. DN 1150 may be connected to one or more other networks, such as a public switched telephone network (“PSTN”), a public land mobile network (“PLMN”), and/or another network. DN 1150 may be connected to one or more devices, such as content providers, applications, web servers, and/or other devices, with which UE 1101 may communicate.

External devices 1154 may include one or more devices or systems that communicate with UE 1101 via 1150 and one or more elements of 1100 (e.g., via UPF/PGW-U 1135). In some embodiments, external device 1154 may include, may implement, and/or may otherwise be associated with IG 105. External devices 1154 may include, for example, one or more application servers, content provider systems, web servers, or the like. External devices 1154 may, for example, implement “server-side” applications that communicate with “client-side” applications executed by UE 1101. External devices 1154 may provide services to UE 1101 such as gaming services, videoconferencing services, messaging services, email services, web services, and/or other types of services.

In some embodiments, external devices 1154 may communicate with one or more elements of environment 1100 (e.g., core network elements) via NEF/SCEF 1149. NEF/SCEF 1149 include one or more devices, systems, VNFs, CNFs, etc. that provide access to information, APIs, and/or other operations or mechanisms of one or more core network elements to devices or systems that are external to the core network (e.g., to external device 1154 via DN 1150). NEF/SCEF 1149 may maintain authorization and/or authentication information associated with such external devices or systems, such that NEF/SCEF 1149 is able to provide information, that is authorized to be provided, to the external devices or systems. For example, a given external device 1154 may request particular information associated with one or more core network elements. NEF/SCEF 1149 may authenticate the request and/or otherwise verify that external device 1154 is authorized to receive the information, and may request, obtain, or otherwise receive the information from the one or more core network elements. In some embodiments, NEF/SCEF 1149 may include, may implement, may be implemented by, may be communicatively coupled to, and/or may otherwise be associated with SEPP 103, which may perform some or all of the functions discussed above. External device 1154 may, in some situations, subscribe to particular types of requested information provided by the one or more core network elements, and the one or more core network elements may provide (e.g., “push”) the requested information to NEF/SCEF 1149 (e.g., in a periodic or otherwise ongoing basis).

In some embodiments, external devices 1154 may communicate with one or more elements of RAN 1110 and/or 1112 via an API or other suitable interface. For example, a given external device 1154 may provide instructions, requests, etc. to RAN 1110 and/or 1112 to provide one or more services via one or more respective MECs 1114. In some embodiments, such instructions, requests, etc. may include QoS parameters, Service Level Agreements (“SLAs”), etc. (e.g., maximum latency thresholds, minimum throughput thresholds, etc.) associated with the services.

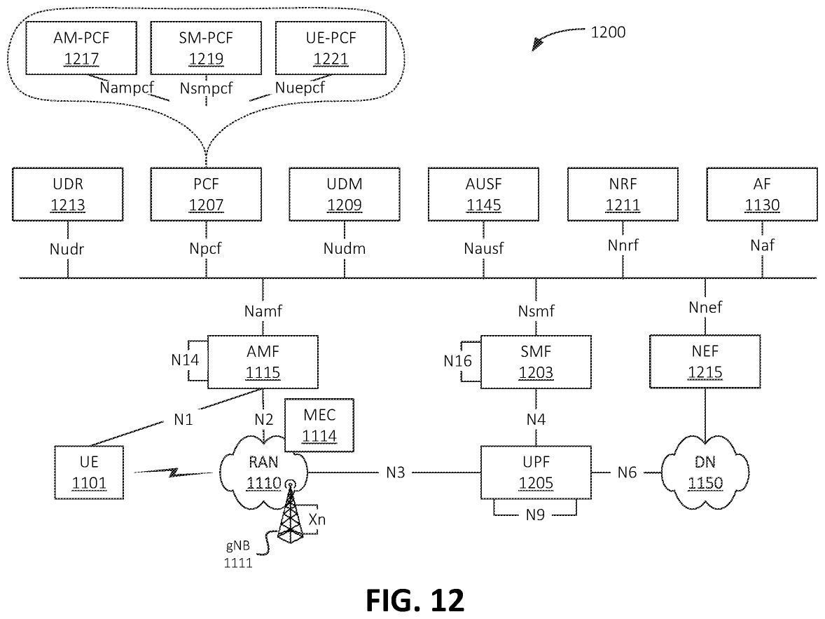

FIG. 12 illustrates another example environment 1200, in which one or more embodiments may be implemented. In some embodiments, environment 1200 may correspond to a 5G network, and/or may include elements of a 5G network. In some embodiments, environment 1200 may correspond to a 5G SA architecture. In some embodiments, environment 1200 may include a 5GC, in which 5GC network elements perform one or more operations described herein.

As shown, environment 1200 may include UE 1101, RAN 1110 (which may include one or more gNBs 1111 or other types of wireless network infrastructure) and various network functions, which may be implemented as VNFs, CNFs, etc. Such network functions may include AMF 1115, SMF 1203, UPF 1205, PCF 1207, UDM 1209, AUSF 1145, Network Repository Function (“NRF”) 1211, AF 1130, UDR 1213, and NEF 1215. Environment 1200 may also include or may be communicatively coupled to one or more networks, such as Data Network DN 1150.

The example shown in FIG. 12 illustrates one instance of each network component or function (e.g., one instance of SMF 1203, UPF 1205, PCF 1207, UDM 1209, AUSF 1145, etc.). In practice, environment 1200 may include multiple instances of such components or functions. For example, in some embodiments, environment 1200 may include multiple “slices” of a core network, where each slice includes a discrete and/or logical set of network functions (e.g., one slice may include a first instance of SMF 1203, PCF 1207, UPF 1205, etc., while another slice may include a second instance of SMF 1203, PCF 1207, UPF 1205, etc.). Additionally, or alternatively, one or more of the network functions of environment 1200 may implement multiple network slices. The different slices may provide differentiated levels of service, such as service in accordance with different QoS parameters.

The quantity of devices and/or networks, illustrated in FIG. 12, is provided for explanatory purposes only. In practice, environment 1200 may include additional devices and/or networks, fewer devices and/or networks, different devices and/or networks, or differently arranged devices and/or networks than illustrated in FIG. 12. For example, while not shown, environment 1200 may include devices that facilitate or enable communication between various components shown in environment 1200, such as routers, modems, gateways, switches, hubs, etc. In some implementations, one or more devices of environment 1200 may be physically integrated in, and/or may be physically attached to, one or more other devices of environment 1200. Alternatively, or additionally, one or more of the devices of environment 1200 may perform one or more network functions described as being performed by another one or more of the devices of environment 1200.

Elements of environment 1200 may interconnect with each other and/or other devices via wired connections, wireless connections, or a combination of wired and wireless connections. Examples of interfaces or communication pathways between the elements of environment 1200, as shown in FIG. 12, may include interfaces shown in FIG. 12 and/or one or more interfaces not explicitly shown in FIG. 12. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1200 may communicate via an SBA, in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1115), an Nudm interface (e.g., indicating communications to be routed to UDM 1209), an Npcf interface, an Nupf interface, an Nnef interface, an Nsmf interface, an Nnrf interface, an Nudr interface, an Naf interface, and/or one or more other SBIs. In some embodiments, environment 1200 may be, may include, may be implemented by, and/or may be communicatively coupled to networks 101-1 and/or 101-2. For example, network 101-1 may include an instance of environment 1200, and network 101-2 may include another instance of environment 1200.

UPF 1205 may include one or more devices, systems, VNFs, CNFs, etc., that receive, route, process, and/or forward traffic (e.g., user plane traffic). As discussed above, UPF 1205 may communicate with UE 1101 via one or more communication sessions, such as PDU sessions. Such PDU sessions may be associated with a particular network slice or other suitable QoS parameters, as noted above. UPF 1205 may receive downlink user plane traffic (e.g., voice call traffic, data traffic, etc. destined for UE 1101) from DN 1150, and may forward the downlink user plane traffic toward UE 1101 (e.g., via RAN 1110). In some embodiments, multiple UPFs 1205 may be deployed (e.g., in different geographical locations), and the delivery of content to UE 1101 may be coordinated via the N9 interface. Similarly, UPF 1205 may receive uplink traffic from UE 1101 (e.g., via RAN 1110), and may forward the traffic toward DN 1150. In some embodiments, UPF 1205 may implement, may be implemented by, may be communicatively coupled to, and/or may otherwise be associated with UPF/PGW-U 1135. In some embodiments, UPF 1205 may communicate (e.g., via the N4 interface) with SMF 1203, regarding user plane data processed by UPF 1205 (e.g., to provide analytics or reporting information, to receive policy and/or authorization information, etc.).

PCF 1207 may include one or more devices, systems, VNFs, CNFs, etc., that aggregate, derive, generate, etc. policy information associated with the 5GC and/or UEs 1101 that communicate via the 5GC and/or RAN 1110. PCF 1207 may receive information regarding policies and/or subscriptions from one or more sources, such as subscriber databases (e.g., UDM 1209, UDR 1213, etc.), and/or from one or more users such as, for example, an administrator associated with PCF 1207. In some embodiments, the functionality of PCF 1207 may be split into multiple network functions or subsystems, such as access and mobility PCF (“AM-PCF”) 1217, session management PCF (“SM-PCF”) 1219, UE PCF (“UE-PCF”) 1221, and so on. Such different “split” PCFs may be associated with respective SBIs (e.g., AM-PCF 1217 may be associated with an Nampcf SBI, SM-PCF 1219 may be associated with an Nsmpcf SBI, UE-PCF 1221 may be associated with an Nuepcf SBI, and so on) via which other network functions may communicate with the split PCFs. The split PCFs may maintain information regarding policies associated with different devices, systems, and/or network functions.

NRF 1211 may include one or more devices, systems, VNFs, CNFs, etc. that maintain routing and/or network topology information associated with the 5GC. For example, NRF 1211 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1213 may include one or more devices, systems, VNFs, CNFs, etc. that provide user and/or subscriber information, based on which PCF 1207 and/or other elements of environment 1200 may determine access policies, QoS policies, charging policies, or the like. In some embodiments, UDR 1213 may receive such information from UDM 1209 and/or one or more other sources.

NEF 1215 include one or more devices, systems, VNFs, CNFs, etc. that provide access to information, APIs, and/or other operations or mechanisms of the 5GC to devices or systems that are external to the 5GC. NEF 1215 may maintain authorization and/or authentication information associated with such external devices or systems, such that NEF 1215 is able to provide information, that is authorized to be provided, to the external devices or systems. Such information may be received from other network functions of the 5GC (e.g., as authorized by an administrator or other suitable entity associated with the 5GC), such as SMF 1203, UPF 1205, a charging function (“CHF”) of the 5GC, and/or other suitable network function. NEF 1215 may communicate with external devices or systems (e.g., external devices 1154) via DN 1150 and/or other suitable communication pathways.

While environment 1200 is described in the context of a 5GC, as noted above, environment 1200 may, in some embodiments, include or implement one or more other types of core networks. For example, in some embodiments, environment 1200 may be or may include a converged packet core, in which one or more elements may perform some or all of the functionality of one or more 5GC network functions and/or one or more EPC network functions. For example, in some embodiments, AMF 1115 may include, may implement, may be implemented by, and/or may otherwise be associated with MME 1116; SMF 1203 may include, may implement, may be implemented by, and/or may otherwise be associated with SGW 1117; PCF 1207 may include, may implement, may be implemented by, and/or may otherwise be associated with a PCRF (e.g., PCF/PCRF 1125); NEF 1215 may include, may implement, may be implemented by, and/or may otherwise be associated with a SCEF (e.g., NEF/SCEF 1149); and so on.

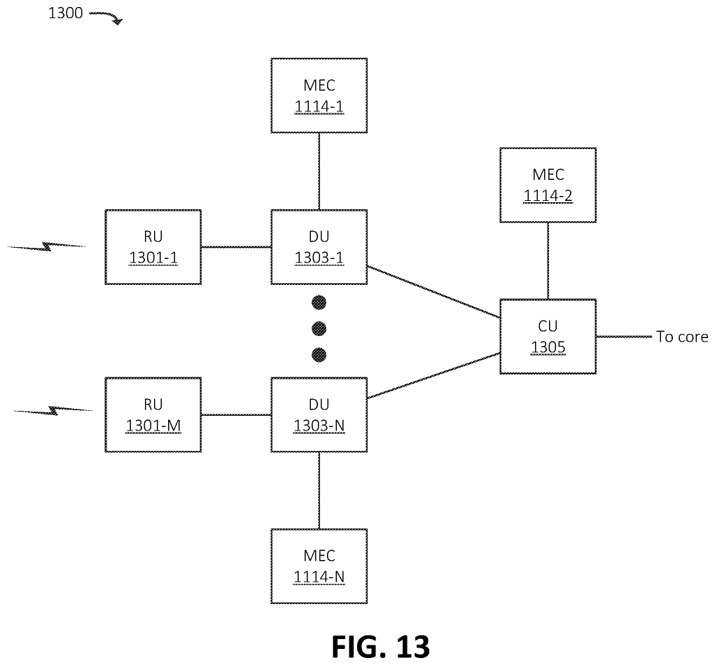

FIG. 13 illustrates an example RAN environment 1300, which may be included in and/or implemented by one or more RANs (e.g., RAN 1110 or some other RAN). In some embodiments, a particular RAN 1110 may include one RAN environment 1300. In some embodiments, a particular RAN 1110 may include multiple RAN environments 1300. In some embodiments, RAN environment 1300 may correspond to a particular gNB 1111 of RAN 1110. In some embodiments, RAN environment 1300 may correspond to multiple gNBs 1111. In some embodiments, RAN environment 1300 may correspond to one or more other types of base stations of one or more other types of RANs. As shown, RAN environment 1300 may include Central Unit (“CU”) 1305, one or more Distributed Units (“DUs”) 1303-1 through 1303-N (referred to individually as “DU 1303,” or collectively as “DUs 1303”), and one or more Radio Units (“RUs”) 1301-1 through 1301-M (referred to individually as “RU 1301,” or collectively as “RUs 1301”).

CU 1305 may communicate with a core of a wireless network (e.g., may communicate with one or more of the devices or systems described above with respect to FIG. 12, such as AMF 1115 and/or UPF 1205). In the uplink direction (e.g., for traffic from UEs 1101 to a core network), CU 1305 may aggregate traffic from DUs 1303, and forward the aggregated traffic to the core network. In some embodiments, CU 1305 may receive traffic according to a given protocol (e.g., Radio Link Control (“RLC”)) from DUs 1303, and may perform higher-layer processing (e.g., may aggregate/process RLC packets and generate Packet Data Convergence Protocol (“PDCP”) packets based on the RLC packets) on the traffic received from DUs 1303.

In accordance with some embodiments, CU 1305 may receive downlink traffic (e.g., traffic from the core network) for a particular UE 1101, and may determine which DU(s) 1303 should receive the downlink traffic. DU 1303 may include one or more devices that transmit traffic between a core network (e.g., via CU 1305) and UE 1101 (e.g., via a respective RU 1301). DU 1303 may, for example, receive traffic from RU 1301 at a first layer (e.g., physical (“PHY”) layer traffic, or lower PHY layer traffic), and may process/aggregate the traffic to a second layer (e.g., upper PHY and/or RLC). DU 1303 may receive traffic from CU 1305 at the second layer, may process the traffic to the first layer, and provide the processed traffic to a respective RU 1301 for transmission to UE 1101.

RU 1301 may include hardware circuitry (e.g., one or more RF transceivers, antennas, radios, and/or other suitable hardware) to communicate wirelessly (e.g., via an RF interface) with one or more UEs 1101, one or more other DUs 1303 (e.g., via RUs 1301 associated with DUs 1303), and/or any other suitable type of device. In the uplink direction, RU 1301 may receive traffic from UE 1101 and/or another DU 1303 via the RF interface and may provide the traffic to DU 1303. In the downlink direction, RU 1301 may receive traffic from DU 1303, and may provide the traffic to UE 1101 and/or another DU 1303.

One or more elements of RAN environment 1300 may, in some embodiments, be communicatively coupled to one or more MECs 1114. For example, DU 1303-1 may be communicatively coupled to MEC 1114-1, DU 1303-N may be communicatively coupled to MEC 1114-N, CU 1305 may be communicatively coupled to MEC 1114-2, and so on. MECs 1114 may include hardware resources (e.g., configurable or provisionable hardware resources) that may be configured to provide services and/or otherwise process traffic to and/or from UE 1101, via a respective RU 1301.

For example, DU 1303-1 may route some traffic, from UE 1101, to MEC 1114-1 instead of to a core network via CU 1305. MEC 1114-1 may process the traffic, perform one or more computations based on the received traffic, and may provide traffic to UE 1101 via RU 1301-1. As discussed above, MEC 1114 may include, and/or may implement, some or all of the functionality described above with respect to UPF 1205, AF 1130, and/or one or more other devices, systems, VNFs, CNFs, etc. In this manner, ultra-low latency services may be provided to UE 1101, as traffic does not need to traverse DU 1303, CU 1305, links between DU 1303 and CU 1305, and an intervening backhaul network between RAN environment 1300 and the core network.

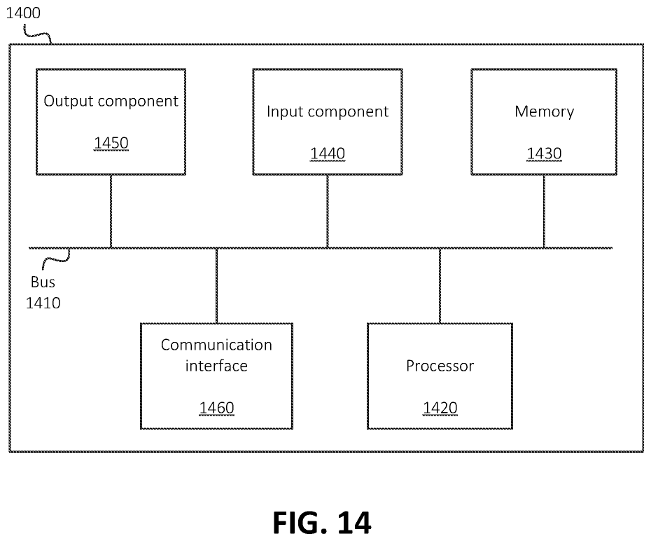

FIG. 14 illustrates example components of device 1400. One or more of the devices described above may include one or more devices 1400. Device 1400 may include bus 1410, processor 1420, memory 1430, input component 1440, output component 1450, and communication interface 1460. In another implementation, device 1400 may include additional, fewer, different, or differently arranged components.

Bus 1410 may include one or more communication paths that permit communication among the components of device 1400. Processor 1420 may include a processor, microprocessor, a set of provisioned hardware resources of a cloud computing system, or other suitable type of hardware that interprets and/or executes instructions (e.g., processor-executable instructions). In some embodiments, processor 1420 may be or may include one or more hardware processors. Memory 1430 may include any type of dynamic storage device that may store information and instructions for execution by processor 1420, and/or any type of non-volatile storage device that may store information for use by processor 1420.

Input component 1440 may include a mechanism that permits an operator to input information to device 1400 and/or other receives or detects input from a source external to input component 1440, such as a touchpad, a touchscreen, a keyboard, a keypad, a button, a switch, a microphone or other audio input component, etc. In some embodiments, input component 1440 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1450 may include a mechanism that outputs information to the operator, such as a display, a speaker, one or more light emitting diodes (“LEDs”), etc.

Communication interface 1460 may include any transceiver-like mechanism that enables device 1400 to communicate with other devices and/or systems (e.g., with RAN 1110, RAN 1112, DN 1150, etc.). For example, communication interface 1460 may include an Ethernet interface, an optical interface, a coaxial interface, or the like. Communication interface 1460 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1400 may include more than one communication interface 1460. For instance, device 1400 may include an optical interface, a wireless interface, an Ethernet interface, and/or one or more other interfaces.

Device 1400 may perform certain operations relating to one or more processes described above. Device 1400 may perform these operations in response to processor 1420 executing instructions, such as software instructions, processor-executable instructions, etc. stored in a computer-readable medium, such as memory 1430. A computer-readable medium may be defined as a non-transitory memory device. A memory device may include space within a single physical memory device or spread across multiple physical memory devices. The instructions may be read into memory 1430 from another computer-readable medium or from another device. The instructions stored in memory 1430 may be processor-executable instructions that cause processor 1420 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-10), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
establish a communication session with a first Security Edge Protection Proxy (“SEPP”) of a first network, and further with a second SEPP of a second network;
receive traffic from the first SEPP;
determine that the traffic satisfies one or more error conditions; and
output, to the first SEPP or the second SEPP, an indication that the traffic satisfies the one or more error conditions.

2. The device of claim 1, wherein determining that the traffic satisfies the one or more error conditions is performed by an intermediary gateway associated with the first SEPP.

3. The device of claim 2, wherein the first SEPP indicates, to the second SEPP, that the intermediary gateway is associated with the first SEPP.

4. The device of claim 3, wherein indicating that the intermediary gateway is associated with the first SEPP includes outputting one or more messages, via an N32-C interface, to the second SEPP, wherein the one or more messages include an identifier of the intermediary gateway.

5. The device of claim 1, wherein the communication session with the first SEPP and the second SEPP is associated with an N32-F interface, wherein the traffic, received from the first SEPP, is received via the N32-F interface.

6. The device of claim 1, further comprising:
receiving a set of parameters or policies from one or more devices associated with the first network, wherein the set of parameters or policies include criteria associated with the one or more error conditions,
wherein determining that the traffic satisfies the one or more error conditions includes:
comparing attributes of the traffic to the criteria associated with the one or more error conditions, and
determining, based on the comparing, that the attributes of the traffic satisfy the criteria associated with the one or more error conditions.

7. The device of claim 1, wherein the one or more processors are further configured to:
maintain an error reporting policy specifying that the first SEPP should be notified regarding the one or more error conditions and that the second SEPP should not be notified regarding the one or more error conditions,
wherein outputting the indication that the traffic satisfies the one or more error conditions includes outputting the indication to the first SEPP without outputting the indication to the second SEPP.

8. A non-transitory computer-readable medium, storing a plurality of processor-executable instructions to:
establish a communication session with a first Security Edge Protection Proxy (“SEPP”) of a first network, and further with a second SEPP of a second network;
receive traffic from the first SEPP;
determine that the traffic satisfies one or more error conditions; and
output, to the first SEPP or the second SEPP, an indication that the traffic satisfies the one or more error conditions.

9. The non-transitory computer-readable medium of claim 8, wherein determining that the traffic satisfies the one or more error conditions is performed by an intermediary gateway associated with the first SEPP.

10. The non-transitory computer-readable medium of claim 9, wherein the first SEPP indicates, to the second SEPP, that the intermediary gateway is associated with the first SEPP.

11. The non-transitory computer-readable medium of claim 10, wherein indicating that the intermediary gateway is associated with the first SEPP includes outputting one or more messages, via an N32-C interface, to the second SEPP, wherein the one or more messages include an identifier of the intermediary gateway.

12. The non-transitory computer-readable medium of claim 8, wherein the communication session with the first SEPP and the second SEPP is associated with an N32-F interface, wherein the traffic, received from the first SEPP, is received via the N32-F interface.

13. The non-transitory computer-readable medium of claim 8, further comprising:
receiving a set of parameters or policies from one or more devices associated with the first network, wherein the set of parameters or policies include criteria associated with the one or more error conditions,
wherein determining that the traffic satisfies the one or more error conditions includes:
comparing attributes of the traffic to the criteria associated with the one or more error conditions, and
determining, based on the comparing, that the attributes of the traffic satisfy the criteria associated with the one or more error conditions.

14. The non-transitory computer-readable medium of claim 8, wherein the plurality of processor-executable instructions further include processor-executable instructions to:
maintain an error reporting policy specifying that the first SEPP should be notified regarding the one or more error conditions and that the second SEPP should not be notified regarding the one or more error conditions,
wherein outputting the indication that the traffic satisfies the one or more error conditions includes outputting the indication to the first SEPP without outputting the indication to the second SEPP.

15. A method, comprising:
establishing a communication session with a first Security Edge Protection Proxy (“SEPP”) of a first network, and further with a second SEPP of a second network;
receiving traffic from the first SEPP;
determining that the traffic satisfies one or more error conditions; and
outputting, to the first SEPP or the second SEPP, an indication that the traffic satisfies the one or more error conditions.

16. The method of claim 15, wherein determining that the traffic satisfies the one or more error conditions is performed by an intermediary gateway associated with the first SEPP.

17. The method of claim 16, wherein the first SEPP indicates, to the second SEPP, that the intermediary gateway is associated with the first SEPP, wherein indicating that the intermediary gateway is associated with the first SEPP includes outputting one or more messages, via an N32-C interface, to the second SEPP, wherein the one or more messages include an identifier of the intermediary gateway.

18. The method of claim 15, wherein the communication session with the first SEPP and the second SEPP is associated with an N32-F interface, wherein the traffic, received from the first SEPP, is received via the N32-F interface.

19. The method of claim 15, further comprising:
receiving a set of parameters or policies from one or more devices associated with the first network, wherein the set of parameters or policies include criteria associated with the one or more error conditions,
wherein determining that the traffic satisfies the one or more error conditions includes:
comparing attributes of the traffic to the criteria associated with the one or more error conditions, and
determining, based on the comparing, that the attributes of the traffic satisfy the criteria associated with the one or more error conditions.

20. The method of claim 15, further comprising:
maintain an error reporting policy specifying that the first SEPP should be notified regarding the one or more error conditions and that the second SEPP should not be notified regarding the one or more error conditions,
wherein outputting the indication that the traffic satisfies the one or more error conditions includes outputting the indication to the first SEPP without outputting the indication to the second SEPP.
